(19) United States
(12) Patent Application Publication
(10) Pub. No.: US 2009/0287600 A1
(43) Pub. Date: Nov. 19, 2009

(54) AUTOMATICALLY UPDATING RECORDS OF CORPORATE EXPENSE SYSTEMS USING CATEGORY SPECIFIC PAYMENT MECHANISMS BASED ON POINT OF SALE ACQUIRED DATA

(75) Inventors: LORENZO AMOROSA, BOJANO (IT); MARGHERITA DE CESARE, ROME (IT); RICCARDO PIZZUTILO, ROME (IT); SARA SEVERONI, ROME (IT)

Correspondence Address: PATENTS ON DEMAND, P.A.-IBM ACCSPP, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/121,212

(22) Filed: May 15, 2008

(51) Int. Cl. G06Q 20/00; G06F 21/00

(52) U.S. Cl. 705/39; 726/27

(57) ABSTRACT

A solution for charging purchases and tracking corporate expenses. In the solution, at least one payment artifact having credit allocations specifically associated with an expense category of a corporate expense management system can be established. A purchase transaction involving the payment artifacts can be identified. An expense category can be automatically determined based upon a payment artifact used for the purchase transaction. Records of the corporate expense management system can be automatically updated based upon the purchase transaction.

### BACKGROUND OF THE INVENTION

The present invention relates to the field of corporate expense management, more particularly, to automatically updating records of corporate expense systems using category specific payment instruments based upon point of sale acquired data.

Some jobs require a significant amount of travelling. These jobs can require an employee to purchase a significant amount of goods or services that their company will pay for. Some companies can give employees corporate credit cards, while others require their employees to first pay their own expenses, and then reimburse them later. When employees pay their own expenses first, the employee is out of money they may need. Creating an expense report to be reimbursed can be troublesome and is subject to human error. When reimbursement is late and employees have initially paid expenses to be reimbursed with a credit card, credit card charges can be incurred by the employee, which can be problematic. Employees often are resentful of having to front expense costs for corporate mandated expenses for achieving corporate objectives. This resentment can increase overbilling abuse of reimbursement systems and can discourage company advantageous travel.

Companies often utilize different categories of reimbursable expenses, which are tracked in a corporate expense management system. For example, travel, food, lodging, conference expenses, etc. can be different expense categories. Use of these categories helps the company better track expenses and can minimize abuses. Categorizing costs during a trip can be a frustrating and time-consuming endeavor for travelers. Further, these expense tracking systems currently require manual entry of expense data. This manual entry can be manpower intensive, can be subject to transcription errors, and generally slows down the reimbursement cycle.

### SUMMARY OF THE INVENTION

A solution comprising a method, computer program product, and system for charging purchases and tracking expenses. In the solution, at least one payment artifact can be established having credit allocations specifically associated with an expense category of a corporate expense management system. A purchase transaction involving the payment artifacts can be identified. An expense category can be determined based upon a payment artifact used for the purchase transaction. Records of the corporate expense management system can be automatically updated based upon the purchase transaction. The purchase transaction can be a transaction involving the payment artifact and a commercial-off-the-shelf point of sale system. The payment artifact can be credit card, a prepaid card, a virtual credit card, a debit card, and/or an electronic payment service. Credit allocations for the payment artifact can be temporally valid only for a duration of an approved event specified by the corporate expense management system. The payment artifact is associated with a specific individual. In one embodiment, the payment artifact can include two or more payment artifacts, each of which are associated with an artifact specific expense category. In another embodiment, the payment artifact can be associated with two or more different authorization tokens, each of which is associated with a different expense category.

When the solution is implemented within a computer program product, the computer program product can include a computer usable medium having computer usable program code embodied therewith. The computer usable program code can be configured to cause a machine to perform each of the actions of the solution in accordance with programmatic instructions of the computer usable program code.

### BRIEF DESCRIPTION OF THE SEVERAL VIEWS OF THE DRAWINGS

FIG. 1 is a schematic diagram of a system for a payment system in which category specific charges are automatically conveyed to a corporate expense management system in accordance with an embodiment of the inventive arrangements disclosed herein.

FIG. 2 illustrates a set of scenarios for using category specific payment artifacts linked to corporate expense accounting system in accordance with an embodiment of the inventive arrangements disclosed herein.

FIG. 3 is a flow chart of a method for using payment artifacts linked to corporate expense categories in accordance with an embodiment of the inventive arrangements disclosed herein.

### DETAILED DESCRIPTION OF THE INVENTION

The present invention permits payment artifacts to be created, which are directed towards specific corporate travel expense categories and users. Entries in a corporate management system can authorize a traveler defined travel amounts per category. These allotments can be used to dynamically generate and/or adjust credit limits on payment artifacts, such as debit cards, credit cards, prepaid cards, virtual credit cards, and other payment processing services (e.g., PAYPAL, GOOGLE CHECKOUT, etc.). In one embodiment, different temporary personal identification numbers (PINs) or other authorizing token can be established against a single payment artifact, where each different PIN is associated with a specific payment category. An expiry date can be established for the payment artifact that is suitable for the travel times. Changes in a corporate expense management system can result in real-time and/or dynamic adjustments being made to already issued payment artifacts. Thus, allotments per category available through issued payment artifacts can be dynamically adjusted to meet travel needs and/or business objectives whenever the corporate expense accounting system is adjusted. As costs are incurred, data regarding the costs and cost categories can be automatically provided to the corporate expense accounting system. Thus, manual entries to the corporate expense accounting system are minimized, accuracy is improved, and response times are increased.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including, but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, for instance, via optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

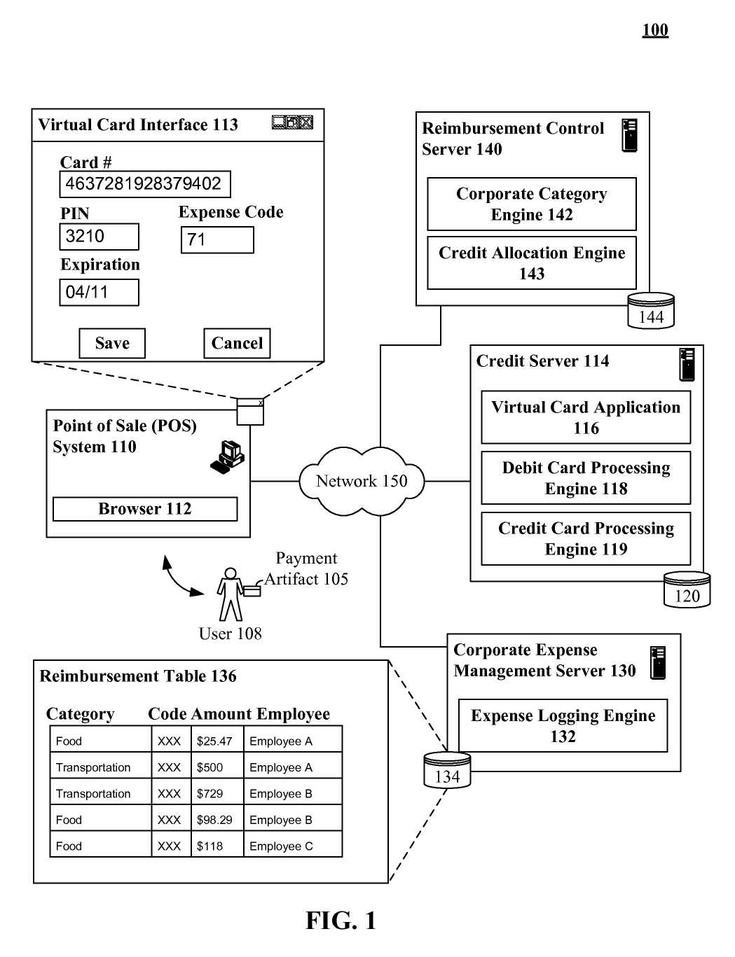

FIG. 1 is a schematic diagram of a system 100 for a payment system in which category specific charges are automatically conveyed to a corporate expense management system in accordance with an embodiment of the inventive arrangements disclosed herein.

In system 100, a corporate expense management server 130 (e.g., a corporate expense management system) can authorize a user 108 to charge an amount to a corporation for a reimbursable or funded event (e.g., corporate trip, meeting, etc.). This amount can be divided into a series of different expense categories. This information can be conveyed to a reimbursement control server 140. After credit allotments are made by category, payment artifacts 105 (e.g., credit cards, debit cards, prepaid cards, etc.) can be issued to an associated user 108. Alternatively, previously “blank” or disabled payment artifacts 105 can be charged or allocated additional credit in accordance with the credit allocations. Use of the payment artifact 105 can require an authorization token, which can be provided to user 108 via any secure communication channel. In one embodiment, credit allocations can be temporally constrained to be active only during a time period associated with the trip, as specified by the corporate expense management server 130.

Once charged a payment artifact 105 can be used by the user 108 as if it is a standard payment artifact 105. Charges incurred using payment artifact 105 are recorded by expense category. This category specific expense information is conveyed to corporate expense management server 130, where it is able to be accepted by an expense logging engine 132. This engine 132 can appropriately store the received data in a structured data store 134, which is shown by reimbursement table 136. For example, expenses incurred by user 108 are automatically processed and sorted by category, code, amount, date, etc. The structured expense data can be formatted to conform and/or be interoperable with standards of any corporate expense management system. That is, without manual entry, a corporate expense management server 130 has access to actual event expenses incurred by users 108, which are placed in suitable formats along with all needed attributes. This expedites the reimbursement process, saves manual effort, and permits dynamic adjustments to be made via the corporate expense management server 130.

In one implementation, the reimbursement control server 140 can function as a proxy between a point of sale system 110 and a credit server 114, which is engaged during purchases. That is, a point of sale system 110 can request authorization for a purchase from server 140. The server 140 can directly convey requests to a suitable external credit server 114 for approval, while recording expense category and sales information. The credit server 114 can be a credit approving center, which is able to approve one or more type of POS 110 transactions involving payment artifacts 105. For example, the credit server 114 can include a virtual card application 116, which automatically generates and/or approves virtual credit cards. In another embodiment, the credit server 114 can include a debit card processing engine 118 and/or a credit card processing engine 119 for approving debit/credit card transactions respectively. Approval/denial responses can be sent from the credit server 114 to server 140, which forwards them onto the point of sale system 110.

In one embodiment, a user 108 can enter a “category PIN” which is one generated specifically for a reimbursable or funded event and which may not be recognized by credit server 114 as valid. In this situation, the reimbursement control server 140 can map the category PIN to an expense category using corporate category engine 142. It can then check using credit allocation engine 143 whether sufficient allocated funds in that expense category exist. If so, the reimbursement control server 140 can determine an actual payment source, which can involve determining a “real PIN” linked to the payment artifact 105. This real PIN can be conveyed to the credit server 114 along with the charging request, which produces a response sent to server 140 and forwarded to POS system 110. In one configuration, functionality expressed for the reimbursement control server 140 can be embedded within a credit server 114 as opposed to being separately implemented.

In another implementation, the reimbursement control server 140 can be treated as a payment provider (owner of the payment artifact 105) by the credit server 114. The reimbursement control server 140 can therefore be a proxy owner, which receives information from the credit server 114, processes it to conform to standards of corporate expense management server 130, conveys server 130 suitable expense data by category based upon data received from one or more credit servers 114, and then forwards the payment information received from server 114 onto a suitable owner and/or system, such as an accounting system. In one embodiment, the corporate expense management server 130 can receive information directly from the credit server 114 and processing functions shown for server 140 can be performed by components of server 130.

As used herein, a payment artifact 105 can be any artifact able to be used to pay for goods or services. For example, a payment artifact 105 can include a credit card, a debit card, a smart card, a RFID loaded credit, and other payment processing services/artifacts (e.g., PAYPAL, GOOGLE CHECKOUT, etc.). A payment artifact 105 can be a physical object as well as virtual one. For example, interface 113 presented in browser 112 shows an embodiment where payment artifact 105 is a dynamically generated virtual card. In one implementation, server 140 can generate the card number, pin, and expense code shown in the interface 113 given appropriate authentication information from user 108. This dynamically generated card number can be submitted to credit server 114 and utilized as if it were a standard charge card.

Point of sale system 110 can be a computing device capable of making point of sale transactions. Point of sale system 110 can include components such as a monitor, additional price display, product scanner, keyboard, mouse, cash drawer, a network transceiver, and the like.

Reimbursement control server 140, credit server 114, and corporate expense management server 130 can each be computing devices, such as a server, an interactive cluster of devices, a virtual device operating in a distributed computing space, and the like. The various servers 140, 114, 130 can store and access data contained in a number of data stores 120, 134, 144.

The data stores 120, 134, 144 can be physically implemented within any type of hardware including, but not limited to, a magnetic disk, an optical disk, a semiconductor memory, a digitally encoded plastic memory, a holographic memory, or any other recording medium. The data stores 120, 134, 144 can be a stand-alone storage unit as well as a storage unit formed from a plurality of physical devices, which may be remotely located from one another. Additionally, information can be stored within each data store in a variety of manners. For example, information can be stored within a database structure or can be stored within one or more files of a file storage system, where each file may or may not be indexed for information searching purposes.

The various components of system 100 can be communicatively linked to one another via network 150. Network 150 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 150 can include local components and data pathways necessary for communications to be exchanged among computing device components and between integrated device components and peripheral devices. The network 150 can also include network equipment, such as routers, data lines, hubs, and intermediary servers which together form a packet-based network, such as the Internet or an intranet. The network 150 can further include circuit-based communication components and mobile communication components, such as telephony switches, modems, cellular communication towers, and the like. The network 150 can include line based and/or wireless communication pathways.

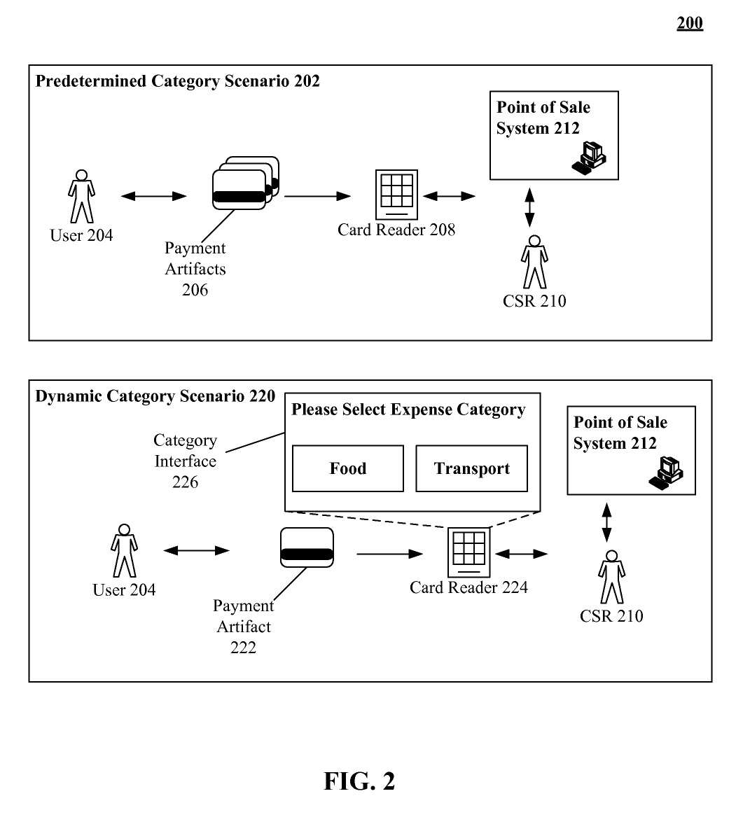

FIG. 2 illustrates a set of scenarios 202, 220 for using category specific payment artifacts linked to corporate expense accounting system in accordance with an embodiment of the inventive arrangements disclosed herein. The scenarios, which include a predetermined category scenario 202 and a dynamic category scenario 220, can occur in context of system 100.

In the predetermined category scenario 202, a number of payment artifacts (or authorization tokens for a single payment artifact) can be created, each associated with an expense category of a corporate expense management system. The different payment artifacts 206 can each have a category specific maximum allotment of funds. This allotment can also be specific to a particular event. The artifacts 206 can be either one-time use generated for a specific occasion or reusable artifacts having changing specifics depending upon event specifics depending upon implantation choices. For example, in one embodiment, each corporate employee 204 who travels can have a payment artifact (e.g., a debit card) issued to them, which is by default deactivated. For each trip the employee 204 makes, expense category specific PINs for the payment artifact can be generated. These PINs can be self-expiring so that they are only active for the dates of the event.

As shown in scenario 202, different payment artifacts 206 are generated for each expense category. A user can insert the payment artifact 206 into a card reader 208 or other input mechanism of a point of sale 212 system. The point of sale system 212 treats the payment artifacts 206 as if they are standard ones (i.e., standard pre-paid cards, debit cards, credit cards, virtual credit cards, etc. depending on implementation specifics). A customer server representative (CSR) 210 can optionally assist the transaction. As transactions happen, expense metrics can be automatically conveyed to a corporate expense management system by category. Appreciably, scenario 202 utilizes unmodified commercial-off-the-shelf point of sale systems 212 and card readers 208.

Dynamic category scenario 220 illustrates a scenario in which a single payment artifact 222 is used with a point of sale system 212, which prompts a user 204 for category information. In one embodiment, corporate handling data digitally encoded in payment artifact 222 can inform the point of sale 212 system that a corporate expense transaction is occurring. That is, when a payment artifact 222 is placed in a card reader 224, point of sale system 212 determines that it is being used for corporate travel and a special interface 226 is presented to user 204. This interface can be a standard GUI present in many commercial point of sale systems, where software has been updated to be responsive to corporate expenses. Once a category has been entered in category interface 226, sales can proceed as normal. In one embodiment, if a PIN or other authorizing token is entered by user 204, that PIN must match a category specific PIN (if any) for the point of sale system 212 to approve the transaction.

It should be noted that scenario 220 can requires a modification to retailing point of sale systems 212, but can utilize standard payment artifacts 222 for transactions to effectively achieve the same functional results as scenario 202. Retailers in scenario 220 can be incentivized to make these relatively simplistic changes to their point of sale 212 systems, as it can offer a competitive advantage in the marketplace. For example, a large company can only authorize travelers to utilize retailers who support a corporate expense tracking capabilities. Scenario 220 contemplates an emergence of an open standard for interactions between corporate expense management systems and point of sale systems.

An additional advantage inherent in scenario 220 is that it permits retailers to offer user transparent incentives, loyalty programs, discounts, etc. to corporations utilizing their products/services in bulk for their travelers. These corporate discounts can be automatically applied without effecting market pricing of the retailer goods as a whole (since the discounts and percentages may only be known to the corporation and the retailer). It should be noted that a point of sale system of scenario 202 can be modified to provide retailer visibility to a fact that expenses by user 204 are for corporate purposes to achieve the advantages discussed in scenario 220.

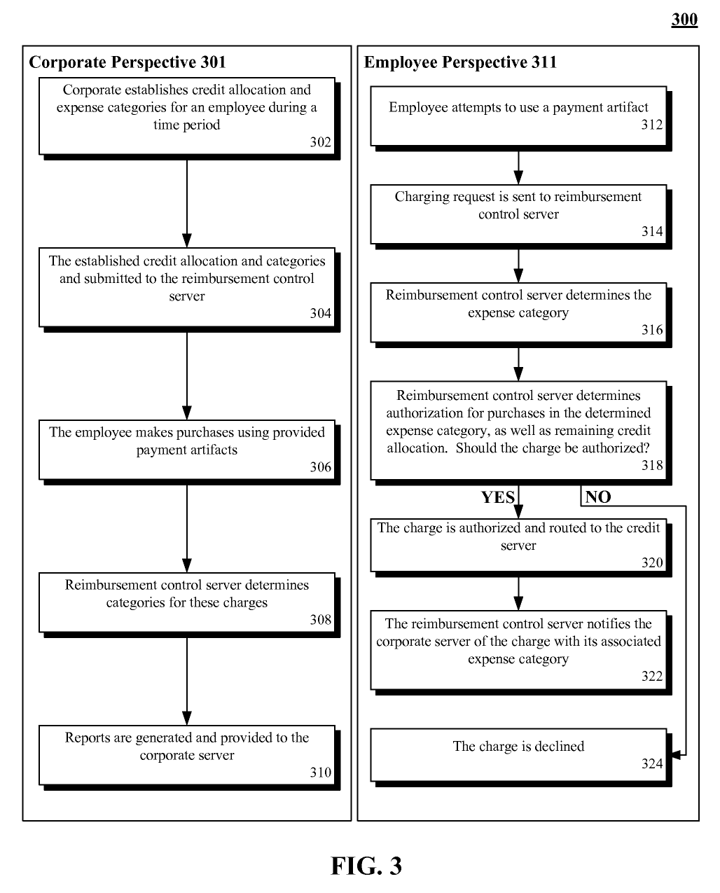

FIG. 3 is a flow chart of a method 300 for using payment artifacts linked to corporate expense categories in accordance with an embodiment of the inventive arrangements disclosed herein. Method 300 can be performed in context of a system 100. Method 300 shows process flows from a corporate perspective 301 and from an employee perspective 311.

Corporate perspective flow 301 can begin in step 302, where a corporation can establish credit allocation and expense categories for an employee during a time period. In step 302, an employee can be approved for a corporate sponsored trip and corporate can establish the dates and expenses the employee will be allowed. In step 304, the established credit allocation and categories are submitted to the reimbursement control server. At this time, category specific PINs can be established, pre-paid cards can be charged, virtual cards can be issued, and/or payment artifacts can be provided to the traveler. These actions can happen at the corporate level or at a reimbursement entity level.

In step 306, the employee can makes one or more purchases using the provided payment artifact(s). In step 308, the reimbursement control server can determine categories for these charges. This information can be conveyed to the corporate expense management server. In one embodiment, these conveyances can occur dynamically and in real time. In another embodiment, the reimbursement center can process transactions in batch and convey them to the corporate expense management servers after each processing cycle. In step 310, where the reports can be generated by either the reimbursement center or the corporate expense management system and provided to the corporate personnel for review/evaluation.

It should be noted that even after an initial issuance of a payment artifact (step 304) and an initial credit allocation made (step 302), allocation amounts per artifact can be dynamically adjusted at any time. For example, a change can be made in a corporate expense management server, which is conveyed to the reimbursement center, which adjusts credit limits of the payment artifact(s) accordingly.

It is assumed that an employee is issued a payment artifact before employee perspective process 311 begins. In step 312, an employee can attempt to use an issued payment artifact. This can require an employee provide a category specific token for a general purpose payment artifact. In step 314, the charging request can be sent to the reimbursement control server. In step 316, the reimbursement control server can determine the expense category of the charge. In step 318, the reimbursement control server can determine authorization for purchases in the determined expense category, as well as remaining credit allocation for the category. Also in step 318, the reimbursement control server can compare the charge amount to the remaining allocation for the expense category. If the employee is authorized to make more charges in this category and has enough credit allocation left, the charge should be authorized. The process can then proceed to step 320, where the charge can be authorized and routed to the credit server. In step 322, the reimbursement control server can notify the corporate expense management server of the charge with its associated expense category. In step 318, if the reimbursement control server determines the employee is not authorized to make charges in the expense category, or does not have adequate credit allocation available for the charge, the charge should be declined, as shown by step 324.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for charging purchases and tracking expenses comprising:
establishing at least one payment artifact having credit allocations specifically associated with an expense category of a corporate expense management system;
identifying a purchase transaction involving the payment artifacts;
automatically determining an expense category based upon a payment artifact used for the purchase transaction; and
automatically updating records of the corporate expense management system based upon the purchase transaction, wherein the purchase transaction is a transaction involving the payment artifact and a commercial-off-the-shelf point of sale system, wherein the payment artifact is at least one of a credit card, a prepaid card, a virtual credit card, a debit card, and an electronic payment service, wherein credit allocations for the payment artifact are temporally valid only for a duration of an approved event specified by the corporate expense management system, and wherein the payment artifact is associated with a specific individual.

2. The method of claim 1, wherein said at least one payment artifact comprises a plurality of payment artifacts, each of said plurality of payment artifacts being associated with an artifact specific expense category.

3. The method of claim 1, wherein the payment artifact is associated with a plurality of different authorization tokens, wherein each authorization token is associated with a different expense category.

4. A computer program product for charging purchases and tracking expenses comprising, the computer program product comprising:
a computer usable medium having computer usable program code embodied therewith, the computer usable program code comprising:
computer usable program code configured to establish at least one payment artifact having credit allocations specifically associated with an expense category of a corporate expense management system;
computer usable program code configured to identify a purchase transaction involving the payment artifacts;
computer usable program code configured to automatically determine an expense category based upon a payment artifact used for the purchase transaction; and
computer usable program code configured to automatically update records of the corporate expense management system based upon the purchase transaction, wherein the purchase transaction is a transaction involving the payment artifact and a commercial-off-the-shelf point of sale system, wherein the payment artifact is at least one of a credit card, a prepaid card, a virtual credit card, a debit card, and an electronic payment service, wherein credit allocations for the payment artifact are temporally valid only for a duration of an approved event specified by the corporate expense management system, and wherein the payment artifact is associated with a specific individual.

5. The computer program product of claim 4, wherein said at least one payment artifact comprises a plurality of payment artifacts, each of said plurality of payment artifacts being associated with an artifact specific expense category.

6. The computer program product of claim 4, wherein the payment artifact is associated with a plurality of different authorization tokens, wherein each authorization token is associated with a different expense category.
